(19) United States
(12) Patent Application Publication
(10) Pub. No.: US 2009/0114894 A1
(43) Pub. Date: May 7, 2009

(54) Universal Sheave Wheel Adapter

(76) Inventors: ALVIN ROOKS, MISSOURI CITY, TX (US); UMAIR MARFANI, STAFFORD, TX (US); JAMES F. MINEAR, CONWAY, AR (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 12/212,829

(22) Filed: Sep. 18, 2008

Related U.S. Application Data
(60) Provisional application No. 60/973,329, filed on Sep. 18, 2007.

(51) Int. Cl. B66D 3/04

(52) U.S. Cl. 254/415

(57) ABSTRACT

An assembly is provided that includes an oilwell rig; a sheave wheel adapter connected to the rig; a sheave wheel yoke connected to the adapter; and a sheave wheel connected to the yoke. In various embodiments of the invention, this assembly is configured to permit the wheel to rotate about three mutually perpendicular planes of motion.

### CROSS-REFERENCE TO RELATED APPLICATION

This application claims priority under 35 U.S.C. § 119(e) to U.S. Provisional Application Ser. No. 60/973,329, filed on Sep. 18, 2007, which is incorporated herein by reference.

### FIELD OF THE INVENTION

The present invention relates generally to a wireline logging sheave wheel adapter, and more particularly to a wireline logging sheave wheel adapter that connects a sheave wheel to an oilwell rig in a manner that allows the sheave wheel freedom to rotate in any direction.

### BACKGROUND

A wireline logging sheave wheel 10 is typically attached to a pad eye 12 of an oilwell rig (a support structure member on the structure of a drilling unit, production platform, pulling unit or temporary suitable support structure) with chains, shackles and sheave hangers. However, there are instances where these items cannot be used, forcing the sheave wheel 10 to be attached by its yoke 14 directly to the pad eye 12 of the rig. Such an arrangement is shown in FIGS. 1A-1B. When this is done, the connection of the sheave wheel 10 to the pad eye 12 allows for rotation of the pad eye about a Z axis (i.e., a plane coming out of the page with respect to FIG. 1A), but not about an X axis (i.e., a plane extending horizontally across the page with respect to FIG. 1A.) Thus, the sheave wheel 10 does not have a full range of rotation or a full range of motion.

When a sheave wheel is not permitted a full range of motion, a wireline cable disposed in a groove 16 of the sheave wheel 10 can be damaged or even severed if it “jumps out” or disengages from the sheave's groove 16. Accordingly, it is often desirable to allow a sheave wheel to have a full range of motion while it is attached to an oilwell rig. Therefore, a need exists for a device and/or method which efficiently allows for a full range of motion of a sheave wheel when it is connected to an oilwell rig.

### SUMMARY

In one embodiment of the present invention, a sheave wheel adapter is connected to an oilwell rig pad eye in a manner that allows a wheel attached to the adapter to rotate in two planes of motion. A yoke, which swivels about its own longitudinal axis, may then be connected between the adapter and the wheel to allow the wheel to rotate about a third plane. In this manner, a universal freedom of motion for the sheave wheel is achieved while it is attached to an oilwell rig. That is, the sheave wheel is allowed to rotate “universally” about three planes of motion. The problem of a wireline logging cable jumping out of the sheave's groove is thereby eliminated by allowing the sheave wheel to “follow” the cable, keeping the cable aligned with the groove and thereby preventing its escape or detachment therefrom.

### BRIEF DESCRIPTION OF THE DRAWINGS

These and other features and advantages of the present invention will be better understood by reference to the following detailed description when considered in conjunction with the accompanying drawings wherein:

FIG. 1A is a side view of a sheave wheel connected to an oilwell rig according to a method of the prior art;

FIG. 1B is a front view of FIG. 1A;

FIG. 2A is a side view of a sheave wheel connected to an oilwell rig by a sheave wheel adapter according to one embodiment of the present invention (note that FIG. 2A includes a legend defining the X, Y and Z planes of FIG. 2A);

FIG. 2B is a front view of FIG. 2A (note that the X, Y and Z planes are rotated with respect to FIG. 2A, showing the rotation of FIG. 2B with respect to FIG. 2A);

FIG. 3 is an enlarged cross-sectional view of detail 3 from FIG. 2B;

FIG. 4 is a sheave wheel adapter according to one embodiment of the present invention having a twist for coupling an upper portion of the adapter to a lower portion of the adapter;

FIG. 5 is an alternative embodiment to the adapter of FIG. 4;

FIG. 6 is a sheave wheel adapter according to one embodiment of the present invention having a hinge mechanism for coupling an upper portion of the adapter to a lower portion of the adapter; and

FIG. 7 is an alternative embodiment to the adapter of FIG. 6.

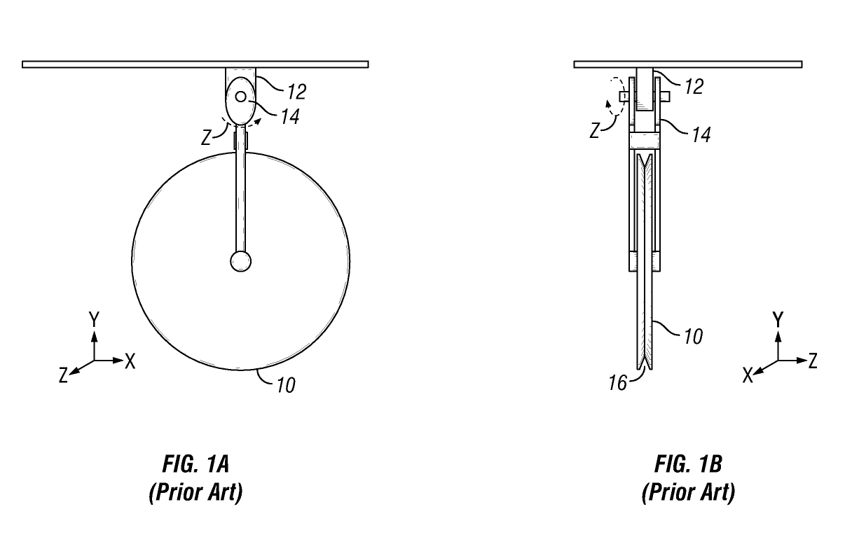

### DETAILED DESCRIPTION OF EMBODIMENTS OF THE INVENTION

In embodiments of the invention, described below, a sheave wheel adapter according to the present invention is provided that allows for a connection of a wireline sheave wheel to an oilwell rig in a manner that permits the sheave wheel freedom to rotate in any plane (i.e., freedom to rotate universally).

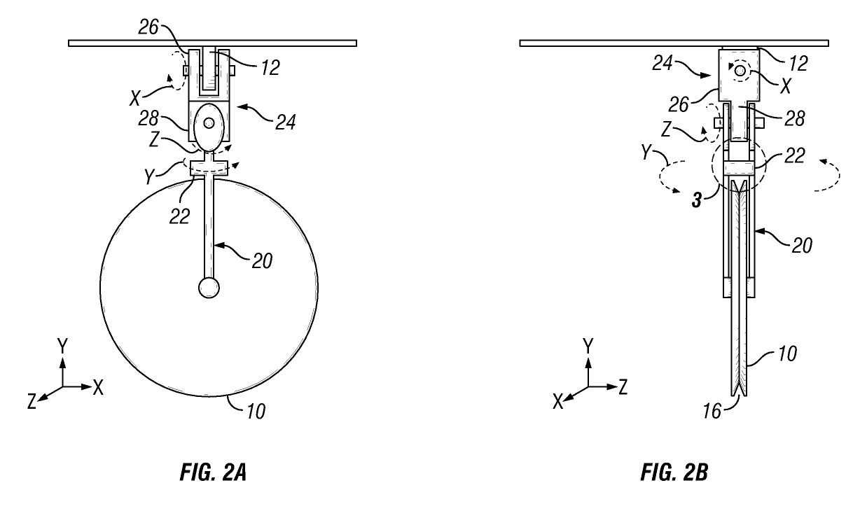

For example, in the embodiment of FIGS. 2A-2B, a sheave wheel yoke is connected to the axel of a sheave wheel 10. In some embodiments, the yoke 20 may be adapted to rotate about its own longitudinal axis, or a Y axis (i.e., a plane extending vertically across the page with respect to FIG. 2A.) As such, in these embodiments, the sheave wheel 10 is also able to rotate about the longitudinal axis of the yoke 20, or the Y axis. This rotational capability of the sheave wheel 10 is shown by rotational arrow Y in FIG. 2A.

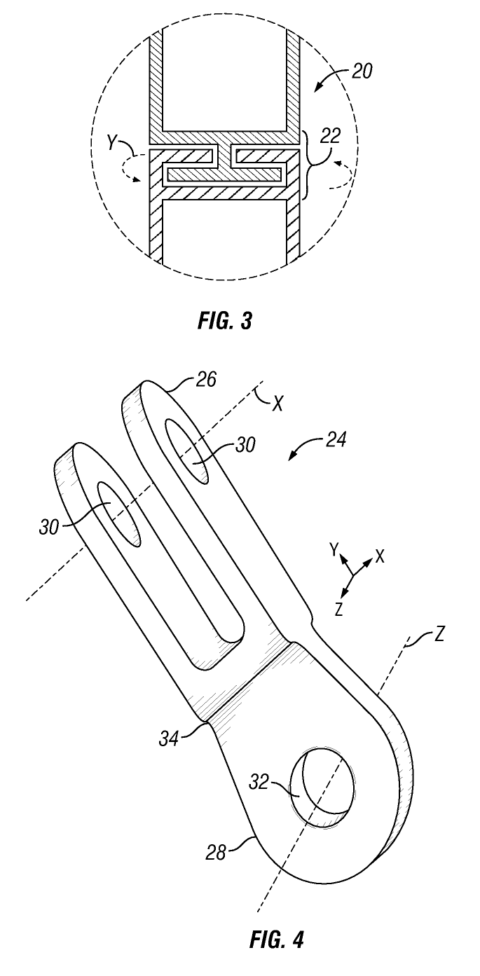

FIG. 3 shows an exemplary embodiment of the yoke 20, wherein an upper portion of the yoke combines with a lower portion of the yoke to form a swivel connection 22, such that the upper portion of the yoke is allowed to rotate relative to the lower portion of the yoke. Note however, that although FIG. 3 shows a swivel connection 22, any appropriate connection may be used which allows the upper portion of the yoke to rotate relative to the lower portion of the yoke, such as a ball joint, or another appropriate configuration.

Referring back to the assembly shown in FIGS. 2A-2B, a lower portion of the yoke 20 is connected to the sheave wheel 10 and an upper portion of the yoke 20 is connected to a lower portion of a sheave wheel adapter 24. An upper portion of the sheave wheel adapter 24, in turn, is connected to a pad eye 12 of an oilwell rig. Each of these connections (i.e., the sheave wheel 10 to the yoke 20; the yoke 20 to the sheave wheel adapter 24; and the sheave wheel adapter 24 to the oilwell rig pad eye 12) may be made by a pin connection, among other appropriate connections.

As described below, the sheave wheel adapter 24 is constructed such that a sheave wheel 10 attached thereto is allowed to rotate about a first axis, or an X axis (i.e., a plane extending horizontally across the page with respect to FIG. 2A) that is perpendicular to the longitudinal axis of the yoke 20, or the Y axis. This rotational capability of the sheave wheel 10 is shown by rotational arrow X in FIG. 2A.

In addition, the sheave wheel adapter 24 is constructed such that the sheave wheel 10 is allowed to rotate about a second axis, or a Z axis (a plane coming out of the page with respect to FIG. 2A) that is perpendicular to both the X axis and the Y axis. This rotational capability of the sheave wheel 10 is shown by rotational arrow Z in FIG. 2A. Thus, with the combination of the yoke 20 and the sheave wheel adapter 24, the sheave wheel 10 is connected to the oilwell rig pad eye 12 in a manner that allows the sheave wheel 10 to rotate universally, in each plane of motion (for example the X, Y and Z axes of FIG. 2A.)

FIGS. 4-7 show various exemplary embodiments of the sheave wheel adapter 24. That is, any of the embodiments of FIGS. 4-7 may be used as the sheave wheel adapter 24 in FIGS. 2A-2B to allow the sheave wheel 10 in FIGS. 2A-2B to move universally in all three planes of motion. Specifically, in each embodiment shown in FIGS. 4-7, the sheave wheel adapter 24 may be used with the sheave wheel 10 of FIGS. 2A-2B to allow the sheave wheel 10 to rotate in all three planes of motion, with two axes of rotation being provided by the sheave wheel adapter 24, and the third axis of rotation being provided by a swivel connection 22 in the yoke 20 that allows the yoke 20 to rotate about its longitudinal axis.

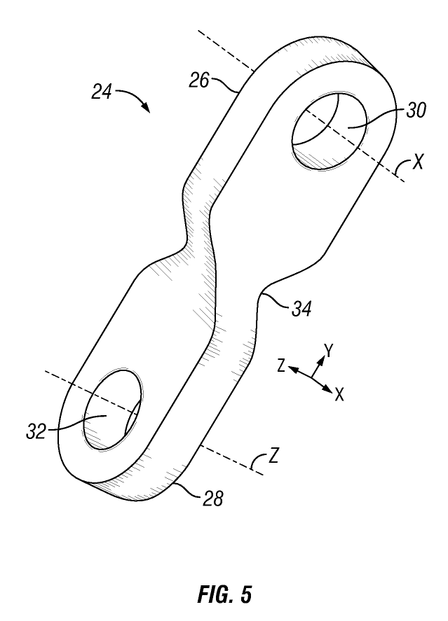

FIGS. 4 and 5 show embodiments of the sheave wheel adapter 24 according to the present invention. In these embodiments, the adapter 24 includes an upper portion 26 for connection to the oilwell rig pad eye 12, and a lower portion 28 for connection to the sheave wheel yoke 20. In these embodiments, the upper portion 26 of the adapter 24 defines an opening(s) 30 for receiving a pin for connection to the oilwell rig pad eye 12; and the lower portion 28 of the adapter 24 defines an opening(s) 32 for receiving a pin for connection to the sheave wheel yoke 20. Note however, that in these and in each of the embodiments described below, other attachment mechanisms may be used for attaching the adapter 24 to the oilwell rig pad eye 12 and/or other attachment mechanisms may be used for attaching the adapter 24 to the sheave wheel yoke 20.

In the embodiments of FIGS. 4 and 5, the upper portion 26 of the adapter 24 and the lower portion 28 of the adapter 24 are coupled by a twist 34, such as a 90° twist, which allows the axis of rotation of a pin inserted into the opening(s) 30 of the upper portion 26 of the adapter 24 to be perpendicular to the axis of rotation of a pin inserted into the opening(s) 32 of the lower portion 28 of the adapter 24. For example, using the X, Y and Z planes as defined by FIG. 2A, when the adapter 24 of FIG. 4 or 5 is connected to the oilwell rig pad eye 12 as shown in FIG. 2A, the opening(s) 30 in the upper portion 26 of the adapter 24 allow the sheave wheel 10 to rotate about the X axis; and the opening(s) 32 in the lower portion 28 of the adapter 24 allow the sheave wheel 10 to rotate about the Z axis.

Note that the oilwell rig pad eye 12 of FIG. 2A is a male connection (a single arm), thus requiring a female connection (two spaced apart arms) in the upper portion 26 of the adapter 24. In addition, the lower portion of the sheave wheel yoke 20 in FIG. 2A includes a female connection, thus requiring a male connection in the lower portion of the adapter 24. However, in some instances the oilwell rig pad eye 12 includes a female connection, and in some instances the lower portion of the sheave wheel yoke 20 includes a male connection. Thus, in alternative embodiments, the upper portion 26 of the adapter 24 may include a female connection (as shown in FIG. 4), or a male connection (as shown in FIG. 5), and the lower portion of the adapter 24 may include a female connection or a male connection (as shown in FIGS. 4 and 5). As such, either option in the upper portion 26 of the adapter 24 (a male or a female connection) may be used in combination with either option in the lower portion 28 of the adapter 24 (a male or a female connection.) Note that in the embodiments of FIGS. 4 and 5, the twist 34 is integrally formed with the upper and lower portions of the adapter 24. Thus, the adapter 24 in each of the embodiments of FIGS. 4 and 5 is formed as a unitary body construction.

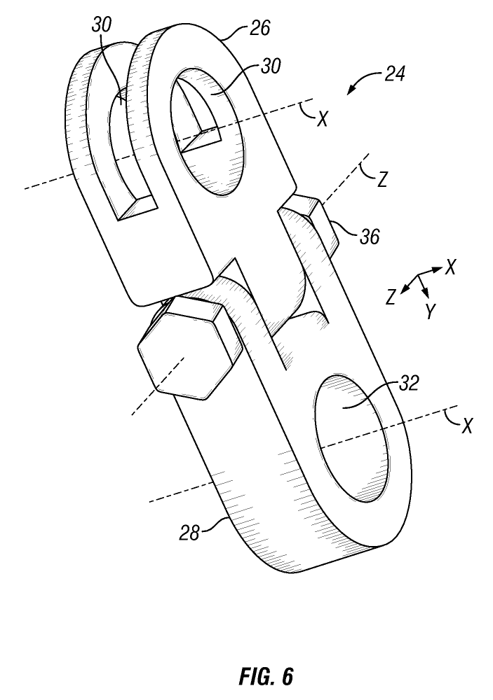

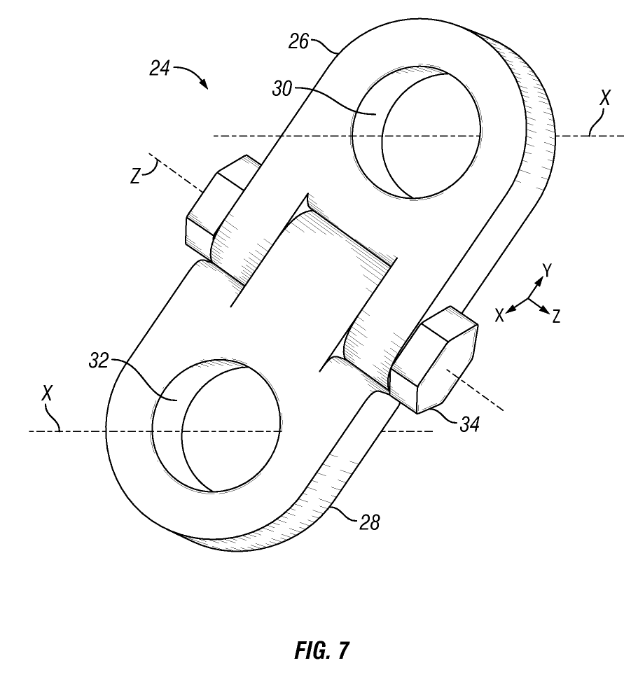

FIGS. 6 and 7 show other embodiments of the adapter 24. In these embodiments, the upper portion 26 of the adapter 24 defines an opening(s) 30 for receiving a pin for connection to the oilwell rig pad eye 12; and the lower portion 28 of the adapter 24 defines an opening(s) 32 for receiving a pin for connection to the sheave wheel yoke 20. Note however, using the X, Y and Z planes as defined by FIG. 2A, when the adapter 24 of FIG. 6 or 7 is connected to the oilwell rig pad eye 12 as shown in FIG. 2A, the opening(s) 30 in the upper portion 26 of the adapter 24 allow the sheave wheel 10 to rotate about the X axis; and the opening(s) 32 in the lower portion 28 of the adapter 24 also allow the sheave wheel 10 to rotate about the X axis. However, in the embodiments of FIGS. 6 and 7, the upper portion 26 of the adapter 24 is coupled to the lower portion of the adapter 24 by a hinge joint 36, thus allowing the upper and lower portions of the adapter 24 to rotate with respect to each other (when the sheave wheel adapter 24 of FIG. 6 or 7 is used in the assembly of FIG. 2A, this rotation is about the Z axis.)

In alternative embodiments, the upper portion 26 of the adapter 24 may include a female connection (as shown in FIG. 6), or a male connection (as shown in FIG. 7), and the lower portion of the adapter 24 may include a female connection or a male connection (as shown in FIGS. 6 and 7). As such, either option in the upper portion 26 of the adapter 24 (a male or a female connection) may be used in combination with either option in the lower portion 28 of the adapter 24 (a male or a female connection.)

Note that any of the adapters 24 described above may be used to support a sheave wheel 10, supporting a cable having a wellbore tool attached thereto. This cable itself can extend for tens of thousands of feet and weigh up to around tens of thousands of pounds. In addition, the attached tool can weigh several thousand pounds. Thus, the total weight supported by any of the adapters 24 described above may be in the tens of thousands of pounds. Also note that although the above descriptions refer to a rig for use in an oilwell, the use of the term oilwell rig as used herein is meant to encompass a rig for use with any hydrocarbon producing well, such as a gas well.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

1. An assembly comprising:
an oilwell rig;
a sheave wheel adapter connected to the rig;
a sheave wheel yoke connected to the adapter; and
a sheave wheel connected to the yoke;
wherein the wheel is permitted to rotate about three mutually perpendicular planes of motion.

2. The assembly of claim 1, wherein the adapter is configured to allow the wheel to rotate about both a first plane of motion and a second plane of motion of said three mutually perpendicular planes of motion.

3. The assembly of claim 2, wherein the yoke is configured to allow the wheel to rotate about a third plane of motion of said three mutually perpendicular planes of motion.

4. The assembly of claim 2, wherein the adapter comprises:
an upper portion comprising a first attachment mechanism which connects the adapter to the rig;
a lower portion comprising a second attachment mechanism which connects the adapter to the yoke; and
a coupling mechanism which connects the upper portion of the adapter to the lower portion of the adapter.

5. The assembly of claim 4, wherein the coupling mechanism is a twist which orients the first attachment mechanism perpendicularly to the second attachment mechanism.

6. The assembly of claim 4, wherein the coupling mechanism is a twist such that the first attachment mechanism allows the wheel to rotate about said first plane of motion and the second attachment mechanism allows the wheel to rotate about said second plane of motion.

7. The assembly of claim 4, wherein the coupling mechanism comprises a hinge mechanism, such that the first attachment mechanism allows the wheel to rotate about said first plane of motion and hinge mechanism allows the wheel to rotate about said second plane of motion.

8. The assembly of claim 4, wherein the upper portion, the lower portion and the coupling mechanism of the adapter are all integrally formed.

9. The assembly of claim 3, wherein the yoke comprises a swivel connection which allows the wheel to rotate about said third plane of motion of said three mutually perpendicular planes of motion.

10. An assembly comprising:
an oilwell rig;
a sheave wheel;
a sheave wheel yoke comprising an upper portion and a lower portion; wherein said lower portion is connected to an axel of the wheel; and
a sheave wheel adapter comprising:
an upper portion comprising a first attachment mechanism which connects the adapter to the rig;
a lower portion comprising a second attachment mechanism which connects the adapter to the upper portion of the yoke; and
a coupling mechanism which connects the upper portion of the adapter to the lower portion of the adapter,
wherein the wheel is permitted to rotate about three mutually perpendicular planes of motion;
wherein the adapter is configured to allow the wheel to rotate about both a first plane of motion and a second plane of motion of said three mutually perpendicular planes of motion; and
wherein the yoke is configured to allow the wheel to rotate about a third plane of motion of said three mutually perpendicular planes of motion.

11. The assembly of claim 10, wherein the coupling mechanism is a twist which orients the first attachment mechanism perpendicularly to the second attachment mechanism.

12. The assembly of claim 10, wherein the coupling mechanism is a twist such that the first attachment mechanism allows the wheel to rotate about said first plane of motion and the second attachment mechanism allows the wheel to rotate about said second plane of motion.

13. The assembly of claim 10, wherein the coupling mechanism comprises a hinge mechanism, such that the first attachment mechanism allows the wheel to rotate about said first plane of motion and hinge mechanism allows the wheel to rotate about said second plane of motion.

14. The assembly of claim 10, wherein the upper portion, the lower portion and the coupling mechanism of the adapter are all integrally formed.

15. The assembly of claim 10, wherein the yoke comprises a swivel connection which allows the wheel to rotate about said third plane of motion of said three mutually perpendicular planes of motion.
